(19) United States
(12) Patent Application Publication
(10) Pub. No.: US 2007/0249319 A1
(43) Pub. Date: Oct. 25, 2007

(54) Power distribution communication system employing gateway including wired and wireless communication interfaces

(76) Inventors: Mark A. Faulkner, Greenwood, SC (US); Jose A. Gutierrez, Menomonee Falls, WI (US); Wayne M. Tatko, Greenwood, SC (US); James L. Lagree, Robinson Township, PA (US); John R. Moffat, Greenwood, SC (US); Thomas J. Kenny, Pittsburgh, PA (US); Peter J. Theisen, West Bend, WI (US); Carlos H. Rentel, Brookfield, WI (US); Deborah K. Mort, North Fayette Township, PA (US); Daniel A. Hosko, Greentree, PA (US)

Correspondence Address: MARTIN J. MORAN, ESQ.;Eaton Electrical, Inc., Technology & Quality Center, 170 Industry Drive, RIDC Park West, Pittsburg, PA, 15275-1032, US

(21) Appl. No.: 11/409,716

(22) Filed: Apr. 24, 2006

(51) Int. Cl. H04M 9/00

(52) U.S. Cl. 455/402

(57) ABSTRACT

A power distribution communication system includes a plurality of network protectors, a plurality of sensors or devices, a plurality of wirelessly communicating user interfaces, and a gateway. The gateway includes a wired communication network interface structured to communicate with at least one of the network protectors, the sensors or the devices, a first wireless communication network interface structured to wirelessly communicate with at least one of the network protectors, the sensors or the devices, and a plurality of second wireless communication network interfaces structured to wirelessly communicate with the wirelessly communicating user interfaces. A processor is operatively associated with the wired communication network interface, the first wireless communication network interface and the second wireless communication network interfaces, and is structured to pass data, information and commands between the various interfaces.

This invention was made with Government support under DOE Cooperative Agreement No. DE-FC26-04NT42071 awarded by DOE. The Government has certain rights in this invention.

### BACKGROUND OF THE INVENTION

1. Field of the Invention

The invention relates to power distribution systems and, more particularly, to such systems for communicating with, monitoring and/or controlling network protectors and/or associated equipment, such as sensors and/or devices.

2. Background Information

Low-voltage secondary power distribution networks consist of interlaced loops or grids supplied by two or more sources of power, in order that the loss of any one source will not result in an interruption of power. Such networks provide the highest possible level of reliability with conventional power distribution and are, normally, used to supply high-density load areas, such as a section of a city, a large building or an industrial site.

Each source supplying the network is typically a medium voltage feeder system including a switch, a voltage reducing transformer and a network protector. As is well-known, a network protector is an apparatus used to control the flow of electrical power to a distribution network. The network protector includes a circuit breaker and a control relay which opens the circuit to the transformer upon detection of abnormal current flow. Specifically, the control relay typically senses the network voltages, the line currents and the phasing voltage, and executes algorithms to initiate circuit breaker tripping or re-closing actions. Trip determination is based on detecting reverse power flow, that is, power flow from the network to the primary feeder. Examples of network protector relays are disclosed in U.S. Pat. Nos. 3,947,728; 5,822,165; 5,844,781; and 6,504,693, which are incorporated by reference herein.

Voltage is safely supplied to the network through the transformers, which have their secondary or low-voltage windings connected to the network through the circuit breaker of the corresponding network protector. The transformers and network protectors are often located in vaults, which are frequently underground.

As is also known, control relays typically include a microcontroller-based circuit which monitors the network phase-to-neutral voltages, the phasing voltages and the feeder currents. Traditionally, if a problem with a transformer and/or network protector arose, a worker would need to manually inspect the installation to investigate the problem by physically entering the vault which houses the transformer and/or network protector. This presents serious safety concerns for workers, as the environment inside the vaults is dangerous due to, among other things, the toxic environment and/or the relatively high voltages, currents and temperatures involved.

In order to alleviate this safety concern, the control relays in some systems include a communication module for wired communication with a remote station over a communication network to allow remote access to protector measurement data of interest for both diagnostic and control purposes. In such systems, the control relays perform circuit breaker trip and re-close functions, and the connection to the communication network enables remote tripping, or more specifically, “remote open and block open” control. This allows users, such as electric utility maintenance personnel, to remotely open, and under certain conditions, close the circuit breaker of a network protector, as described in detail in, for example, U.S. Pat. Nos. 5,936,817 and 6,504,693, which are incorporated by reference herein.

FIG. 1 shows a communication subsystem 5 including a number of network protectors 10, which, as described above, may be provided inside a vault located underground. Specifically, the network protectors 10 are connected to a communication cable 15, preferably through an electrical isolation element 20, which, as described below, will allow remote access to protector measurement data of interest. Each network protector 10 includes a communication module (not shown) for communicating with a remote station 25, such as personal computer (PC), over the communication cable 15 (possibly through an electrical isolation element 20). Communication subsystem 5 may utilize a protocol, known as INCOM, and the communication cable 15 may be an INCOM cable. Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein.

The remote station 25 receives network protector measurement data of interest from and sends circuit breaker open and/or close commands to one or more of the network protectors 10 over the communication cable 15. Such a system is, however, typically relatively expensive to implement, as large amounts of cable must be run over long distances.

U.S. Pat. No. 6,628,496 describes a protection system for an electricity network that includes a box containing a processor that causes circuit breakers to open in the event of faults being sensed by current and/or voltage sensors on the lines of the network connected to the circuit breakers. The system also includes a short range radio data transmission link between the box and a remote appliance, such as a mobile telephone, PDA or laptop. As a result, the remote appliance is able to receive data from and send commands to the box wirelessly. This system, however, is a point-to-point system, meaning that a communication channel must be established individually with each such box in order to collect data therefrom or to provide commands thereto. In order to do so, the remote appliance must be brought within the RF transmission range of each such box, which, in most cases, will require a worker to travel over significant distances. As a result, performing diagnostic and control functions with such a protection system is inefficient and time consuming. In addition, such a system requires each box to have its own wireless communication device, which adds to the cost of the system overall.

There is, thus, a need to provide connectivity between network protectors and personnel responsible for network protector up-time, maintenance and operation thereof. Such network protectors are located in widely scattered underground vaults and have the important goal of providing reliable electrical power distribution and protection to critical infrastructure (e.g., large buildings; factories; electrical utilities).

There is room for improvement in communication systems that address local and remote control and monitoring of network protectors, sensors and/or devices.

### SUMMARY OF THE INVENTION

This need and others are met by embodiments of the invention, which provide flexible connectivity through the integration of a set of wireless network technologies. For example, a wireless network architecture comprises wireless personal, local and wide area network technologies integrated through a gateway. The gateway includes, for example, wireless personal, local and wide area communication network interfaces that provide pervasive and flexible control and monitoring of geographically scattered network protectors, sensors and/or devices by personnel located at a remote location (e.g., from a control/monitoring and dispatch center) and/or a local location (e.g., in the vicinity of a network protector, sensor and/or device; at street level).

In accordance with one aspect of the invention, a power distribution communication system comprises: a number of network protectors; a number of sensors or devices; a number of wirelessly communicating user interfaces; and a gateway comprising: a wired communication network interface structured to communicate with at least one of the network protectors, the sensors or the devices, a first wireless communication network interface structured to wirelessly communicate with at least another one of the network protectors, the sensors or the devices, a number of second wireless communication network interfaces structured to wirelessly communicate with the wirelessly communicating user interfaces, and a processor operatively associated with the wired communication network interface, the first wireless communication network interface and the number of second wireless communication network interfaces.

The number of second wireless communication network interfaces may include at least one of a wireless local area communication network interface and a wireless wide area communication network interface.

The number of second wireless communication network interfaces may include a wireless local area communication network interface and a wireless wide area communication network interface.

As another aspect of the invention, a power distribution communication system comprises: a number of network protectors; a number of sensors or devices; a number of wirelessly communicating user interfaces; a wired communication network; a gateway comprising: a wired communication network interface structured to communicate with a first group of some of the network protectors, the sensors or the devices over the wired communication network, a number of first wireless communication network interfaces structured to wirelessly communicate with the wirelessly communicating user interfaces, and a processor operatively associated with the wired communication network interface and the number of first wireless communication network interfaces; and a number of second communication network interfaces structured to provide communications between: (a) the wired communication network interface through the wired communication network, and (b) a second group of some of the network protectors, the sensors or the devices through wireless communications, the second group being different than the first group.

The number of first wireless communication network interfaces may be one first wireless communication network interface.

The one first wireless communication network interface may be a Wi-Fi Hot Spot interface.

The number of first wireless communication network interfaces may be a first wireless communication network interface and a second wireless communication network interface.

The first wireless communication network interface may be a Wi-Fi Hot Spot interface and the second wireless communication network interface may be one of an Ethernet cellular modem, an Ethernet radio modem and a fiber optic modem.

### BRIEF DESCRIPTION OF THE DRAWINGS

A full understanding of the invention can be gained from the following description of the preferred embodiments when read in conjunction with the accompanying drawings in which:

FIG. 1 is a block diagram of a power distribution monitoring and control system.

FIG. 2 is a block diagram of a system providing control and/or monitoring of a plurality of network protectors, sensors and devices over a relatively large geographical region through in-vault communication, local access communication and remote access communication in accordance with an embodiment of the invention.

FIG. 3 is a block diagram of a system providing control and/or monitoring of a plurality of network protectors, sensors and devices through in-vault communication and local access communication in accordance with another embodiment of the invention.

FIGS. 4 and 5 are block diagrams of systems providing control and/or monitoring of a plurality of network protectors, sensors and devices through in-vault communication and local access communication similar to FIG. 3, but also providing remote access communication though a cell phone modem and radio modems, respectively, in accordance with other embodiments of the invention.

FIGS. 6 and 7 are block diagrams of systems similar to FIGS. 4 and 5, but providing a separate serial uplink to the cell phone modem and the in-vault radio modem, respectively, in accordance with other embodiments of the invention.

FIG. 8 is a block diagram of a system similar to FIG. 6, but providing remote access communication though a fiber optic modem in accordance with another embodiment of the invention.

FIG. 9 is a block diagram of a system providing control and/or monitoring of a plurality of network protectors, sensors and devices over a relatively large geographical region through in-vault communication, local access communication and remote access communication in accordance with another embodiment of the invention.

FIGS. 10-14 are block diagrams of systems providing control and/or monitoring of a plurality of network protectors, sensors and devices over a relatively large geographical region through in-vault communication, local access communication and remote access communication in accordance with other embodiments of the invention.

FIGS. 15-17 are display diagrams employed by the client systems of FIG. 2.

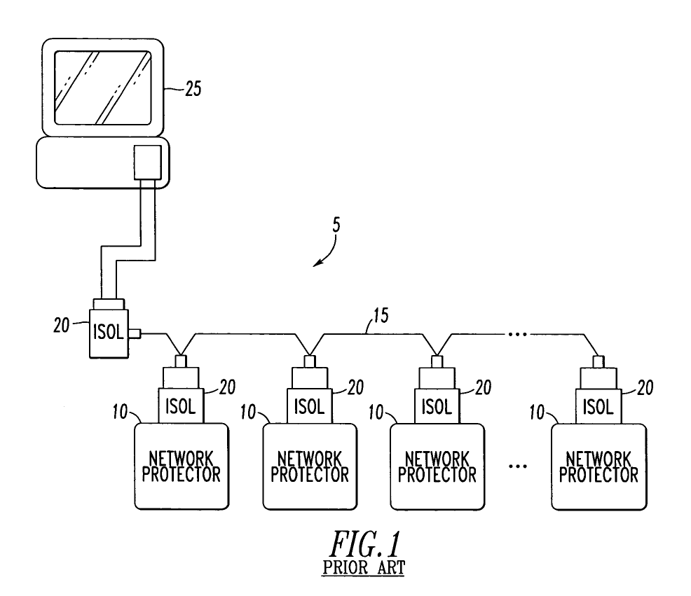

### DESCRIPTION OF THE PREFERRED EMBODIMENTS

As employed herein, the term “number” shall mean one or an integer greater than one (i.e., a plurality).

As employed herein, the term “wireless” shall expressly include, but not be limited by, radio frequency (RF), light, visible light, infrared, ultrasound, wireless area networks, such as, but not limited to, IEEE 802.11 and all its variants (e.g., without limitation, 802.11a; 802.11b; 802.11g), IEEE 802.15 and all its variants (e.g., without limitation, 802.15.1; 802.15.3, 802.15.4), IEEE 802.16 and all its variants, other wireless communication standards (e.g., without limitation, ZigBee™ Alliance standard), HyperLan, DECT, PWT, pager, PCS, Wi-Fi, Bluetooth™, and cellular.

As employed herein, the term “communication network” shall expressly include, but not be limited by, any local area network (LAN), wide area network (WAN), intranet, extranet, global communication network, the Internet, wired communication network and/or wireless communication network.

As employed herein, the term “wireless communication network” means a communication network employing wireless communications.

As employed herein, the term “wired communication network” means a communication network employing non-wireless, wired communications.

As employed herein, the term “sensor” means an apparatus structured to input data or information and to output related data or information to a wireless communication network or a wired communication network. A sensor may optionally include or be operatively associated with zero or a number of devices. Non-limiting examples of sensors include sensors structured to sense temperature, voltage, current, voltage (stray) (e.g., from an energized, conducting surface that might be harmful or lethal to a service person or other person), gas (dissolved), gas (atmospheric), humidity, liquid level, pressure, sudden pressure (e.g., of a transformer compartment which sudden pressure might precede a catastrophic failure) and/or video information.

As employed herein, the term “device” means an apparatus structured to input data, information or a control command from a wireless communication network or a wired communication network and to output corresponding data, corresponding information or a corresponding control action. A device may optionally include or be operatively associated with zero or a number of sensors. Non-limiting examples of devices include fans, actuators, trip units, annunciators, and indicators.

As employed herein, the term “wireless communicating user interface” shall expressly include, but not be limited by, any communicating device having a user input and/or output interface and a wireless communication port (e.g., without limitation, a wireless communicating device; a personal computer (PC); a data phone; a remote control, dispatch or monitoring center; a portable wireless communicating device).

As employed herein, the term “portable wireless communicating device” shall expressly include, but not be limited by, any portable communicating device having a wireless communication port (e.g., without limitation, a portable wireless device; a portable personal computer (PC); a Personal Digital Assistant (PDA); a portable data phone).

As employed herein, the term “gateway” shall expressly include, but not be limited by, any node on any communication network that serves as an entrance and/or exit to and/or from one or more other communication networks that use different operational protocols.

As employed herein, the term “gateway/controller” shall expressly include, but not be limited by, a gateway that is structured to monitor a number of discrete inputs and/or to autonomously react to the discrete inputs and control some number of discrete outputs.

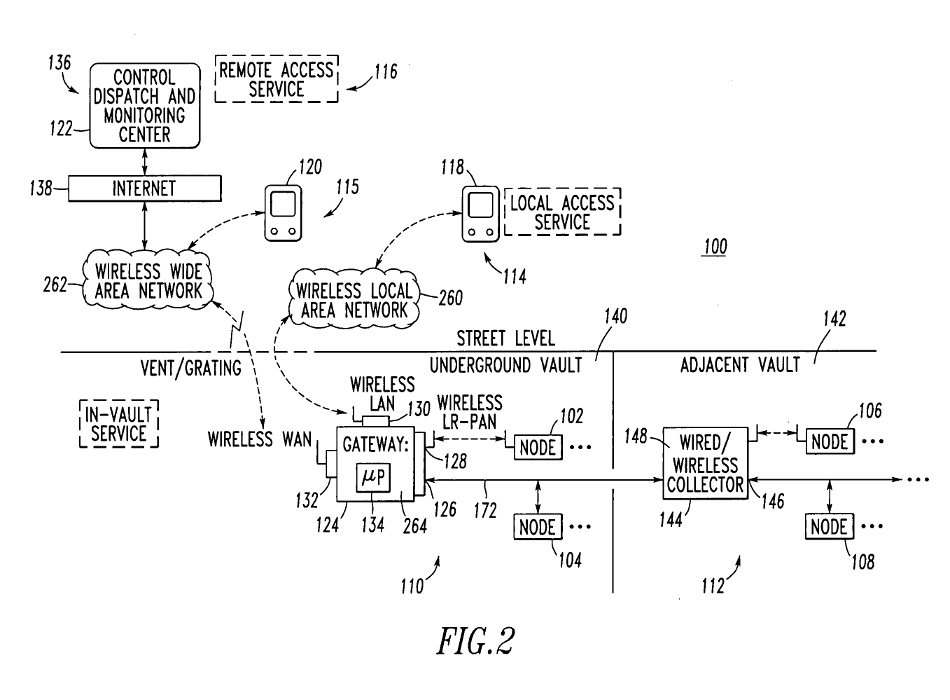

Referring to FIG. 2, a power distribution communication system 100 controls and/or monitors a plurality nodes 102,104,106,108, such as network protectors, sensors and/or devices, over a potentially relatively large geographical region through in-vault communication 110,112, local access communication 114,115 and remote access communication 116. The example system 100 includes a number of the network protectors, sensors or devices, as shown at 102,104,106,108, a number of wirelessly communicating user interfaces, such as 118,120,122, and a gateway 124. The gateway 124 includes a wired communication network interface 126 (e.g., without limitation, INCOM) structured to communicate with a number of the network protectors, sensors or devices, such as 104, a first wireless communication network interface 128 structured to wirelessly communicate with at least another one of the network protectors, sensors or devices, such as 102, a number of second wireless communication network interfaces, such as 130,132, structured to wirelessly communicate with the wirelessly communicating user interfaces, such as 118,120, respectively, and a processor (μP) 134 operatively associated with the wired communication network interface 126, the first wireless communication network interface 128 and the second wireless communication network interfaces 130,132.

### EXAMPLE 1

One of the wirelessly communicating user interfaces 122 is operatively associated with a remote system 136, which is above ground. The example nodes 102,104,106,108 communicate with the gateway 124, and, in this example, are located below ground. The second wireless communication network interface 132 is a wireless wide area communication network (WAN) interface structured to communicate with the remote system 136 through a global communication network, such as the example Internet 138, which may employ wired, wireless and/or fiber optic communication. The remote system 136 is structured to monitor a number of the nodes 102,104,106,108 (e.g., network protectors and/or sensors), control a number of the nodes (e.g., network protectors and/or devices), or accumulate data from a plurality of the nodes (e.g., network protectors and/or sensors) over a geographical region formed by a number of underground vaults, such as 140,142. Although two example vaults are shown, one, three or any suitable number of vaults may be employed.

### EXAMPLE 2

The gateway 124 is located in the underground vault 140 and a plurality of the nodes, such as 106,108 (e.g., network protectors, sensors and/or devices) are located in the other underground vault 142, which, in this example, is adjacent the first underground vault 140. The wired communication network interface 126 is structured to communicate with a wired/wireless data collector 144 including a wired communication network interface 146 communicating with a number of nodes (e.g., network protectors, sensors and/or devices), such as 108, located in the second underground vault 142 and a wireless communication network interface 148 wirelessly communicating with a number of nodes (e.g., network protectors, sensors and/or devices), such as 106, also located in the second underground vault 142.

### EXAMPLE 3

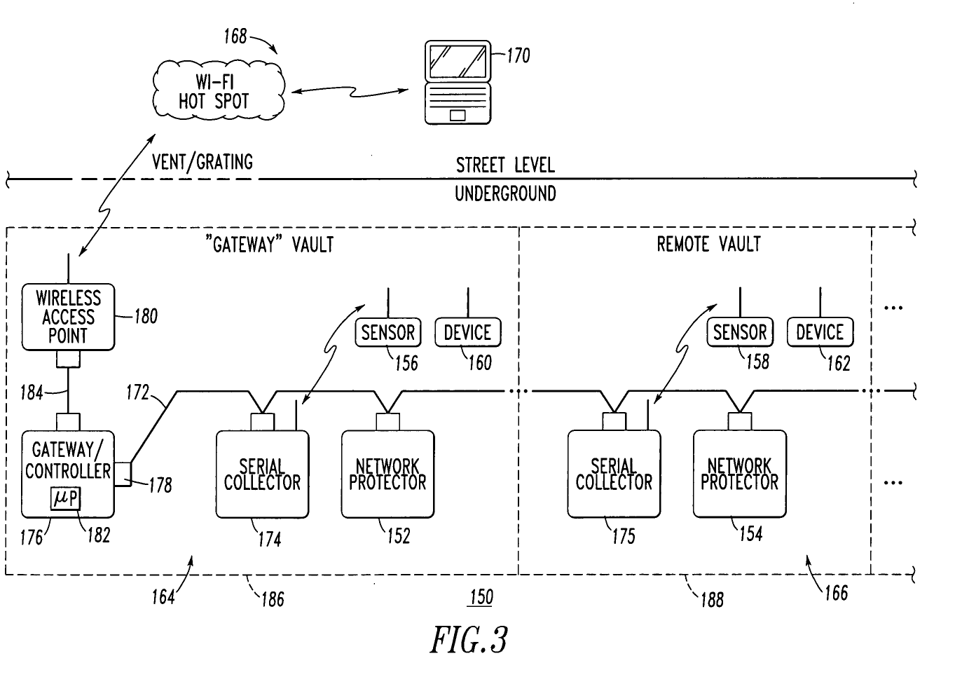

FIG. 3 shows a power distribution communication system 150 providing control and/or monitoring of a plurality of network protectors 152,154, sensors 156,158 and devices 160,162 through in-vault communication 164,166 and local access communication 168 with a number of wirelessly communicating user interfaces, such as the example PDA 170. A wired communication network, such as a serial sub-network (e.g., without limitation, INCOM 172) provides communications among the network protectors 152,154, a number of serial collectors 174,175 and a gateway/controller 176. In this example, the gateway/controller 176 is the master of the INCOM serial sub-network 172, and the other nodes 152,154,174,175 are slaves, although any suitable wired communication network may be employed. The INCOM serial sub-network 172 uses an INCOM cable and the INCOM protocol, although any suitable electrical networking cabling and protocol may be used. The gateway/controller 176 includes a wired communication network interface 178, a number of first wireless communication network interfaces (e.g., without limitation, one wireless access point 180 in this example) structured to wirelessly communicate with the wirelessly communicating user interfaces 170, and a processor (e.g., without limitation, μP 182) operatively associated with the wired communication network interface 178 and the wireless access point 180. Although one wireless access point 180 is shown, a plurality of first wireless communication network interfaces may be employed. In this example, the μP 182 of the gateway/controller 176 employs an Ethernet 10/100 Base-T wired serial communication connection 184 to the wireless access point 180. The wireless access point 180 provides the local access communication 168, which, in this example, is a local Wi-Fi Hot Spot interface (e.g., without limitation, the physical and data-link layers being compliant with the IEEE 802.11b, IEEE 802.11g or IEEE 802.11a standards or any future physical and data-link layer variations specified by the IEEE or any other world standard body) which provides browsing by the example “client” PDA 170 to the underground network protector “server” gear through the in-vault communications 164,166.

The example INCOM wired communication network interface 178 is structured to communicate with a first group of some of the network protectors 152,154, the sensors 156,158 or the devices 160,162 over the INCOM serial sub-network 172. In this example, the INCOM serial sub-network 172 communicates with the example serial collectors 174,175 and the network protectors 152,154. The example serial collectors 174,175 are structured to provide communications between: (1) the wired communication network interface 178 through the INCOM serial sub-network 172, and (2) a second group of some of the network protectors 152,154, the sensors 156,158 or the devices 160,162 through wireless communications. In this example, the serial collector 174 in one underground vault 186 employs wireless communications (e.g., without limitation, ZigBee™ Alliance standard) to communicate with the sensor 156 and the device 160, while the other serial collector 175 in another underground vault 188 employs wireless communications (e.g., without limitation, ZigBee™ Alliance standard) to communicate with the sensor 158 and the device 162.

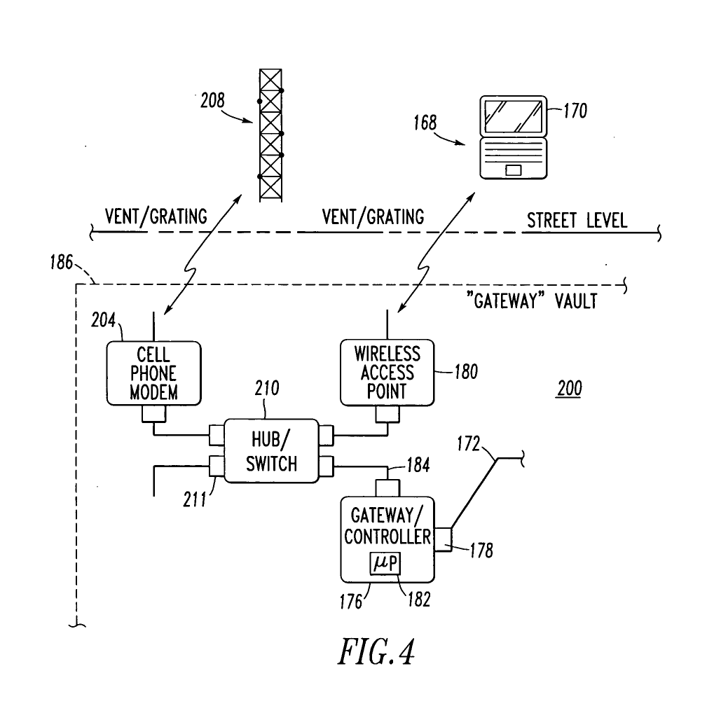

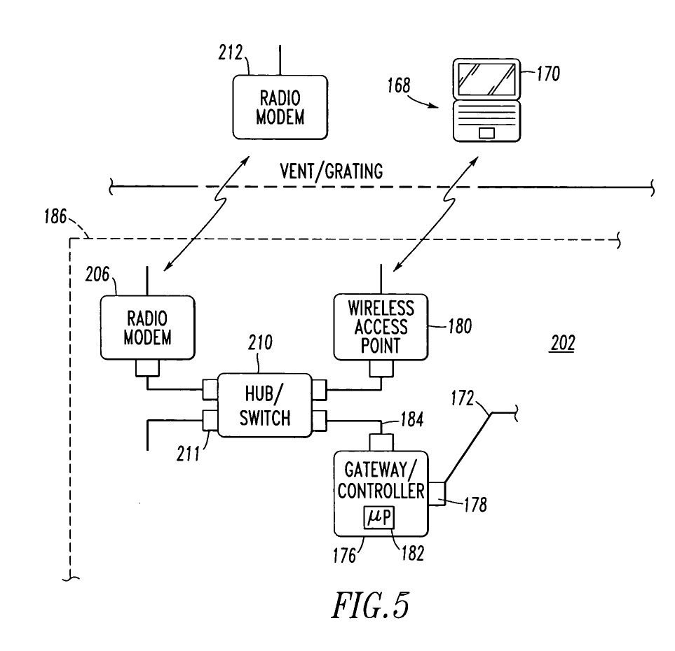

FIGS. 4 and 5 show respective power distribution communication systems 200 and 202, which are somewhat similar to the system 150 of FIG. 3. These systems 200, 202 also provide control and/or monitoring of plural network protectors, sensors and/or devices (as were shown in FIG. 3) through in-vault communication and local access communication similar to FIG. 3 and, further, provide remote access communication though a cell phone modem 204 (FIG. 4) and a radio modem 206 (FIG. 5) as will be described.

### EXAMPLE 4

The system 200 of FIG. 4 provides local communication through the example local Wi-Fi Hot Spot wireless access point 180 and long range communication through the cell phone modem 204 in the underground vault 186 and the above-ground cellular infrastructure 208, both of which provide “client” browsing to the underground network protector “server” gear (FIG. 3). In this example, one wireless communication network interface is provided by the wireless access point 180 and another wireless communication network interface is provided by the cell phone modem 204, both of which communicate with the Ethernet 10/100 Base-T wired serial communication connection 184 through a suitable hub/switch 210. Optionally, the hub/switch 210 provides another interface to another node, such as another gateway/controller (not shown) through port 211.

### EXAMPLE 5

The system 202 of FIG. 5 is similar to the system 200 of FIG. 4 and provides local communication through the example local Wi-Fi Hot Spot wireless access point 180 and long range communication through the example radio modem 206 in the underground vault 186 and an above-ground radio modem 212, both of which provide browsing to the underground network protector gear (FIG. 3). In this example, one wireless communication network interface is provided by the wireless access point 180 and another wireless communication network interface is provided by the radio modems 206,212.

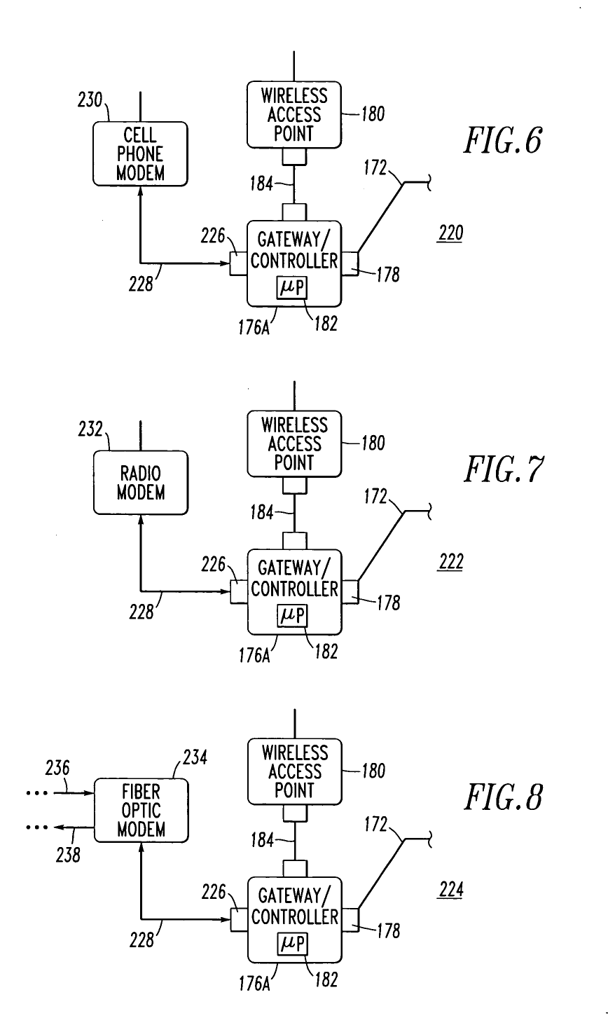

FIGS. 6, 7 and 8 show other respective power distribution communication systems 220, 222 and 224, which are similar to the systems 200 (FIG. 4) and 202 (FIG. 5). These systems employ the example local Wi-Fi Hot Spot wireless access point 180 and, also, provide other serial protocol options for long range data communication through a separate serial uplink 228 from a serial interface 226 of a gateway/controller 176A, which is similar to the gateway/controller 176 of FIGS. 3-5. The serial uplink 228 employs any suitable serial uplink protocol (e.g., without limitation, DNP3, INCOM, Modbus or other suitable protocol (e.g., RS-485, RS-232, FSK). DNP3, for example, is a relatively popular communication protocol of electric utilities. Common request types include read requests, write requests, starting and stopping applications, freezing values to buffers, read event requests, unsolicited messaging, and a variety of administrative and diagnostic requests.

### EXAMPLE 6

The system 220 of FIG. 6 provides long range communication through the serial interface 226 to the serial uplink 228 to an underground Ethernet cell phone modem 230, which may be similar to the cell phone modem 204 of FIG. 4.

### EXAMPLE 7

The system 222 of FIG. 7 provides long range communication through the serial interface 226 to the serial uplink 228 to an underground Ethernet radio modem 232, which is similar to the radio modem 206 of FIG. 5. The system 222 is similar to the system 220 of FIG. 6 except that the Ethernet radio modem 232 is employed in place of the Ethernet cell phone modem 230.

### EXAMPLE 8

The system 224 of FIG. 8 provides long range communication through the serial interface 226 to the serial uplink 228 to an underground Ethernet fiber optic modem 234, which communicates with a remote fiber optic modem (not shown) through fiber optic cables 236,238. The system 224 is similar to the system 220 of FIG. 6 except that the Ethernet fiber optic modem 234 is employed in place of the Ethernet cell phone modem 230.

### EXAMPLE 9

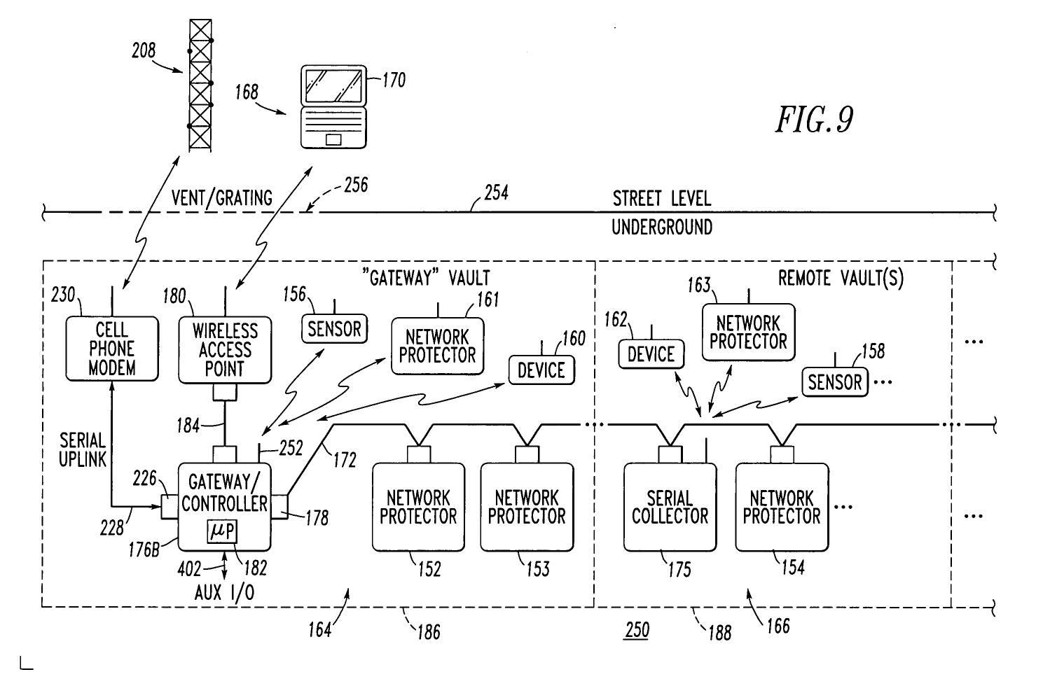

FIG. 9 shows a power distribution communication system 250, which is somewhat similar to the system 150 of FIG. 3 and the system 220 of FIG. 6. Here, however, the example gateway/controller 176B further includes a wireless low rate-personal area network interface 252 (e.g., without limitation, ZigBee™ Alliance standard) to one or more wireless sensors 156, devices 160 or network protectors 161. The system 250 provides control and/or monitoring of plural network protectors 152,153,154,161,163, sensors 156,158 and devices 160,162 over a relatively large geographical region through in-vault communication 164,166, local access communication 168 and remote access communication 208. The example INCOM serial sub-network 172 provides communications among the network protectors 152,153,154, a number of serial collectors, such as 175, and the gateway/controller 176B. The serial collector 175 in the other example underground vault 188 provides communications between: (1) the wired communication network interface 178 through the INCOM serial sub-network 172, and (2) the network protector 163, the sensor 158 and the device 162 through wireless communications.

### EXAMPLE 10

The system 250 of FIG. 9 provides control and/or monitoring of a plurality of network protectors 152,153,154,161,163, sensors 156,158 and devices 160,162 over a relatively large geographical region through, for example, in-vault communication 164,166, local access communication 168 and remote access communication 208. The various sensors, devices and network protectors may be located in geographic proximity with one another, such as at a particular location within an industrial site, or may be located geographically separate from one another, such as in separate parts of an industrial site or even a city. The three example communication services cover geographical regions of different sizes and, thus, provide pervasive control and/or monitoring of the various underground nodes.

The system 250 includes the INCOM serial sub-network 172 and a wireless Zigbee sub-network, through the wireless low rate-personal area network interface 252, that typically, although not necessarily, are located underground, such as under street 254. The network protectors, such as 152, typically include at least a circuit breaker (not shown) and a control relay (not shown), each one operatively coupled to a transformer (not shown) and an associated electrical network (not shown).

### EXAMPLE 11

The example gateway/controllers 176,176A,176B are electronic devices that include among other components: (1) the processor 182, such as, without limitation, a microprocessor, such as a microcontroller, that is programmed for performing the various operations and functions described herein; (2) a number of wireless communication interfaces capable of wirelessly transmitting and receiving data using any of one or more known wireless protocols, including, without limitation, short-range RF protocols such as Bluetooth or Zigbee; (3) a wired communication interface capable of transmitting and receiving data using any suitable wired protocol, including, without limitation, INCOM; and (4) a memory (not shown) for storing data and routines executable by the processor 182.

### EXAMPLE 12

The example gateway/controllers 176,176A,176B provide an In-vault Communication Service (ICS) that directly gathers critical information from the various network protectors, sensors and/or devices located, for example, in a single vault or in plural adjacent underground vaults, and from the environment surrounding the network protectors (e.g., the vaults; the area immediately above the vaults). The ICS provides, for example: (1) the initial data collection from local electronic devices, sensors and/or network protectors; and (2) final delivery of a number of control commands to the network protectors and/or to a number of devices (e.g., fans; actuators) that are part of the network and that are located in the vaults.

The ICS is provided, for example, through a suitable wireless communication network (e.g., without limitation, Zigbee; Low-Rate Personal Area Network (LR-PAN)), such as through the wireless low rate-personal area network interface 252 (FIG. 9), and/or through a suitable wired communication network (e.g., without limitation, INCOM 172).

Non-limiting examples of physical variables that are monitored by the ICS include: temperature, voltage, current, voltage (stray) (e.g., that could energize a sidewalk grating or any unexpected contact surface within the vault), gas (dissolved), gas (atmospheric), humidity, liquid level, pressure, sudden pressure (e.g., of a transformer oil housing), ionizing radiation and/or video information.

### EXAMPLE 13

The various network protectors, sensors and/or devices may be provided within a vault underground. Typically, to provide adequate protection, such vaults are made of concrete and are rather thick (e.g., about 2 to 3 inches or more) and, as a result, wireless signals may not be able to penetrate the concrete. Fortunately, such vaults are also provided with a grating 256 (FIG. 9) or the like for ventilation purposes, and such gratings provide a path for transmission of the wireless signals in cases where the gateway/controller 176B is also placed within the vault. As will be appreciated, the gateway/controller 176B need not be placed within the vault, and instead may be placed in a more convenient, easily accessible location separate from the in-vault components, such as the various network protectors, sensors and/or devices.

### EXAMPLE 14

In this example, the system 250 is a master/slave system. Specifically, gateway/controller 176B is both the INCOM master and the Zigbee master. The network protectors 152,153,154 and the serial collector 175 are INCOM slaves, and the sensor 156, device 160 and network protector 161 are Zigbee slaves, such that data communication is initiated by the gateway/controller 176B either on its own, as described below, or upon receipt of a request from a client system, such as for example and without limitation, a portable wireless communicating device, such as PDA 170, or a remote station (not shown) through remote long range communication through the example above-ground cellular infrastructure 208. Also, the serial collector 175 is a Zigbee master and the sensor 158, device 162 and network protector 163, in this example, are Zigbee slaves.

For example, in one particular embodiment, the gateway/controller 176B may be programmed to automatically and continuously, periodically or upon the occurrence of an event, such as a circuit breaker trip, collect data from one or more of, and preferably all of, the various network protectors, sensors and devices. Once collected, the gateway/controller 176B will then store (log) the data, preferably in a non-volatile manner, for subsequent transmission to the portable wireless communicating device 170 or a remote station (not shown), as described below.

### EXAMPLE 15

The gateway/controller 176B is able to communicate with each of the various network protectors, sensors and/or devices. In particular, the gateway/controller 176B is structured to selectively request and receive data from and provide control commands to each of the various network protectors and devices. As such, the gateway/controller 176B is able to collect data, such as, without limitation, the network phase-to-neutral voltages, the transformer phase-to-neutral voltages, the feeder currents, the circuit breaker status (open or closed), and a stored log or buffer of recent breaker events, that is collected by the microcontroller-based control relay of each network protector, and is able to selectively provide breaker trip and re-close commands to each network protector. For this purpose, each of the various network protectors, sensors and devices is provided with a unique address to enable the gateway/controller 176B to identify it and distinguish it from the other network protectors, sensors and devices.

### EXAMPLE 16

The example gateway/controllers 176,176A,176B provide a Local Access Service (LAS) that employs a suitable Wireless Local Area Network (WLAN) (e.g., without limitation, an IEEE 802.11-based network) to provide communication capabilities for a field operator to control and/or monitor the various network protectors, sensors and/or devices located within vaults that are scattered in a relatively small geographical region (e.g., a city block).

The LAS provides: (1) field operator monitoring of a number of network protectors and their environment; (2) field operator control of a number of network protectors and/or a number of networked devices; and (3) data aggregation of in-vault data tailored for field operation in a relatively small geographical region (e.g., a city block).

The example portable wireless communicating device, which may be, for example and without limitation, a portable personal computer, the PDA 170 or a cell phone, is provided with wireless communication functionality that is compatible with the WLAN LAS employed by the gateway/controller 176B to enable the portable wireless communicating device and the gateway/controller 176B to communicate with one another. As a result, the portable wireless communicating device 170 is able to wirelessly request and receive from the gateway/controller 176B the data that has been collected from each of the various network protectors, sensors and/or devices. In addition, the portable wireless communicating device 170 is able to wirelessly transmit control commands for one or more of the various network protectors and/or devices to the gateway/controller 176B, which then relays them to the appropriate network protectors and/or devices over the corresponding wireless communication network through the wireless low rate-personal area network interface 252 or over the INCOM wired communication network 172 through the INCOM interface 178.

As will be appreciated, the gateway/controller 176B is provided with appropriate hardware and software to enable the data to be converted from the format in which it is received over the example INCOM wired communication network 172 or the example Zigbee wireless low rate-personal area network to the internal format (e.g., without limitation, comma separated value (CSV) files; XML formats; any suitable representation of data in any organized manner) that is employed for processing by wireless gateway/controller 176B and to the format that is employed to transmit it wirelessly to the portable wireless communicating device 170 (e.g., Bluetooth, Wi-Fi, or any other suitable wireless local area network technology) and vice versa.

### EXAMPLE 17

The example gateway/controllers 176A,176B provide a Remote Access Service (RAS) that employs a suitable Wireless Wide Area Network (WWAN) to provide communication capabilities for a remote or mobile operator to control and/or monitor a number of the various network protectors, sensors and/or devices located within vaults that are scattered in a relatively large geographical region (e.g., a city).

Examples of WWANs include, for example, cellular radio networks (e.g., GPRS; IS-95; CDMA2000, 1xEV-DO; GSM) or future IEEE 802.16-based networks.

The RAS provides: (1) mobile or remote operator monitoring of electrical parameters and surrounding network protector environment; (2) mobile or remote operator control of a number of network protectors and/or a number of networked devices; and (3) data aggregation of in-vault and local data tailored to remote and mobile operation in a relatively large geographical region (e.g., a city). The RAS includes services that the Internet can provide and, in particular, those services that can be provided through the client-server paradigm to access remote information via web servers (e.g., as part of the gateway/controllers 176A,176B) and web browsers.

The RAS may include, for example, some of the services of the LAS of Example 16. Therefore, it is possible for a mobile or remote operator to access a network protector, sensor or device through the RAS even if the user is within the LAS range. This can be beneficial, for instance, in case the LAS is temporarily unavailable.

### EXAMPLE 18

Referring again to FIG. 2, the gateway 124 of the system 100 provides communication and information processing from/to the vaults 140,142 to/from the rest of the world. A field operator can potentially connect to a number of the various nodes 102,104,106,108, such as network protectors, sensors and devices, through the local access communications 114,115 provided by the wireless local area network (WLAN) 260, and a remote or mobile operator can connect to a number of network protectors, sensors and devices through the remote system 136 and Internet 138 through remote access communications provided by the wireless wide area communication network (WAN) 262. In this example, a web server 264 (as part of the example gateway 124) provides an Internet-like web browser user interface and limited access service through the Internet 138.

Ideally, a user is interested in secure access to corresponding network protectors, sensors and devices. Therefore, access to/from the Internet 138 is preferably done through a firewall (not shown) and a web server (not shown) connected to an internal network (e.g., a company intranet) (not shown) at the remote system 136. For example, in such an installation, e-mail and/or paging alerts are possible from the information gathered by the gateway 124.

### EXAMPLE 19

The example gateway 124 (FIG. 2) and gateway/controllers 176 (FIG. 3), 176A (FIGS. 6-8) and 176B (FIG. 9) communicate with a number of sensors, devices and/or network protectors in plural adjacent vaults, which are separated by a wall. The example INCOM wired communication network 172 employs the wireless/wired collector 144 (FIG. 2) to gather information from a number of wired and wireless nodes, such as 106,108, that belong to different networks and to transfer such information to the gateway 124. The wireless/wired collector 144 is preferably modular in order to ease the incorporation of a wireless sensor network and/or a wired sensor network depending on the requirements of any particular vault. In this example, there are both a number of sensors, such as 106, of a Zigbee wireless sensor network and a number of sensors, such as 108, of an INCOM wired sensor network in the vault 142.

### EXAMPLE 20

In addition, the example gateway 124 (FIG. 2) and gateway/controllers 176 (FIG. 3), 176A (FIGS. 6-8) and 176B (FIG. 9) may be programmed with appropriate intelligence to perform diagnostics and/or to analyze the data that it receives and generate and transmit appropriate control commands (e.g., without limitation, circuit breaker trip commands; circuit breaker re-close commands) to one or more of the various network protectors and/or devices based thereon.

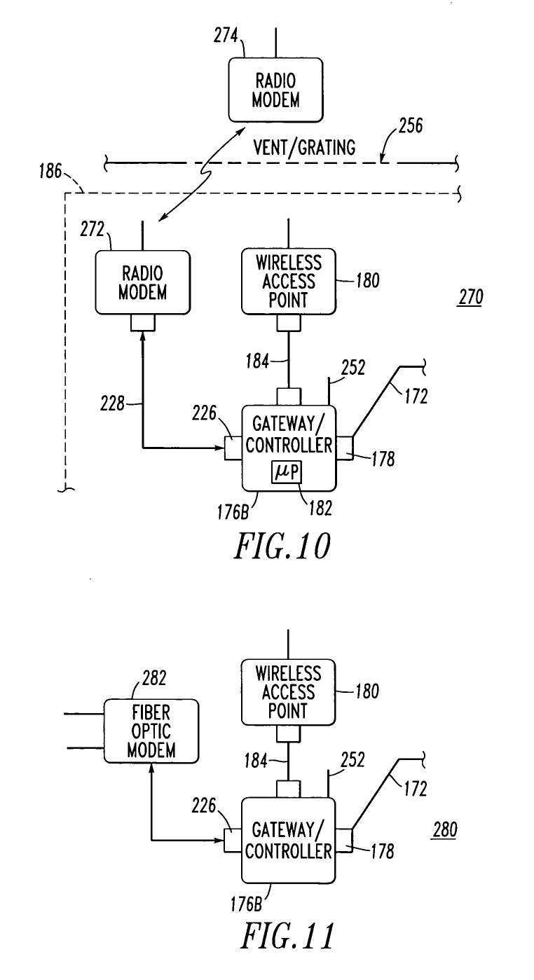

FIGS. 10 and 11 show other respective power distribution communication systems 270 and 280, which are similar to the system 250 of FIG. 9 and employ the example local Wi-Fi Hot Spot wireless access point 180 and, also, provide suitable long range communication.

### EXAMPLE 21

The system 270 of FIG. 10 provides long range communication through an underground radio modem 272 and an above ground radio modem 274, which may be similar to the respective underground radio modems 206 (FIG. 5), 232 (FIG. 7) and the above ground radio modem 212 of FIG. 5.

### EXAMPLE 22

The system 280 of FIG. 11 provides long range communication through a fiber optic modem 282, which may be similar to the fiber optic modem 234 of FIG. 8.

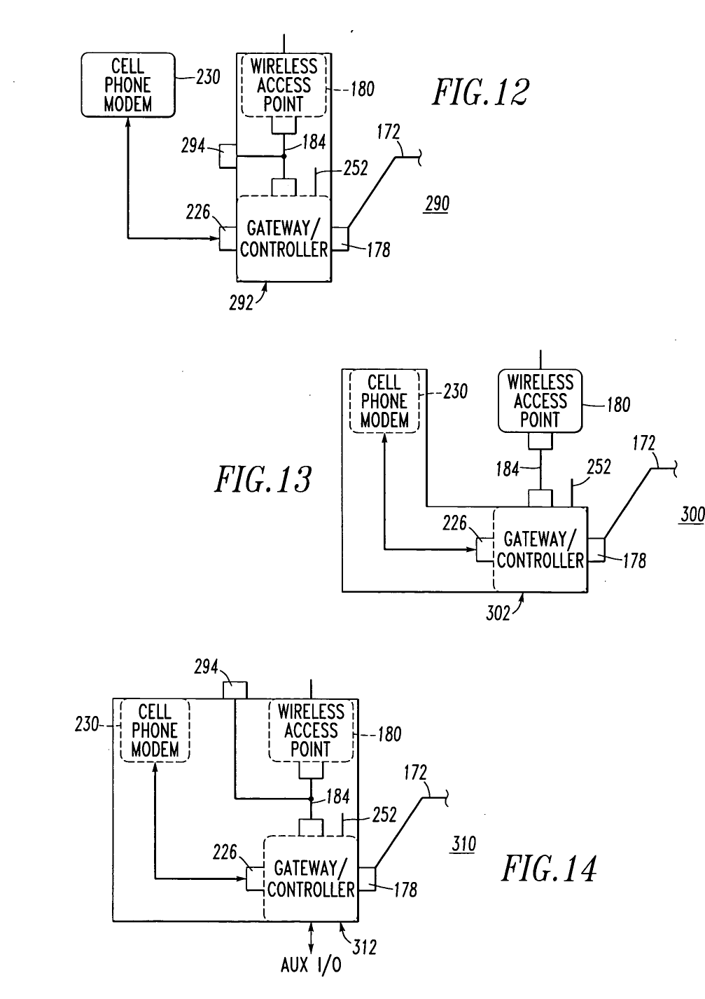

FIGS. 12, 13 and 14 show other respective power distribution communication systems 290, 300 and 310, which are similar to the system 250 of FIG. 9, in which different gateway/controllers 292, 302 and 312, respectively, are employed. The gateway/controllers 292,302,312 are similar to the gateway/controller 176B except as will be described.

### EXAMPLE 23

The gateway/controller 292 of FIG. 12 is similar to the gateway/controller 176B of FIG. 9 except that the gateway/controller 292 integrates the wireless access point 180 and provides a LAN port connector 294 for the example Ethernet connection 184.

### EXAMPLE 24

The gateway/controller 302 of FIG. 13 is similar to the gateway/controller 176B of FIG. 9 except that the gateway/controller 302 integrates the cell phone modem 230.

### EXAMPLE 25

The gateway/controller 312 of FIG. 14 is similar to the gateway/controller 176B of FIG. 9 except that the gateway/controller 302 integrates the wireless access point 180, provides the LAN port connector 294 and integrates the cell phone modem 230.

### EXAMPLE 26

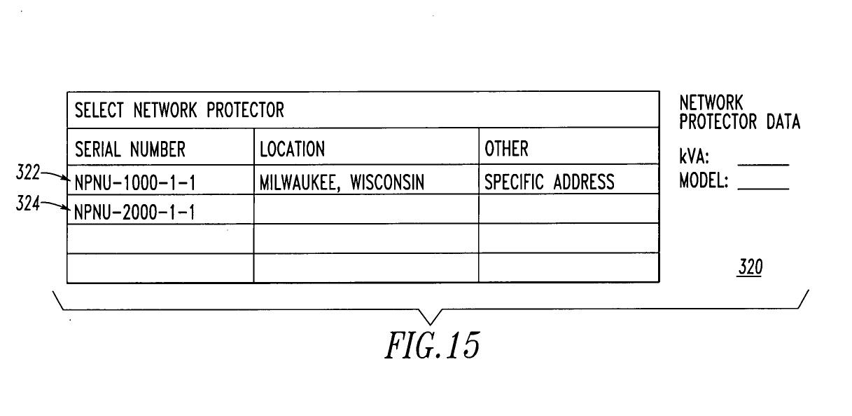

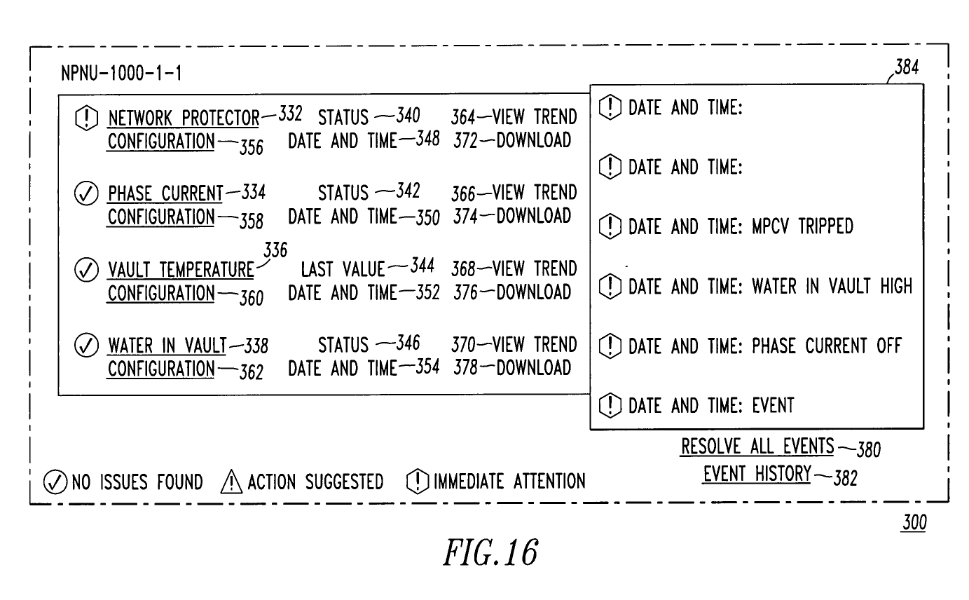

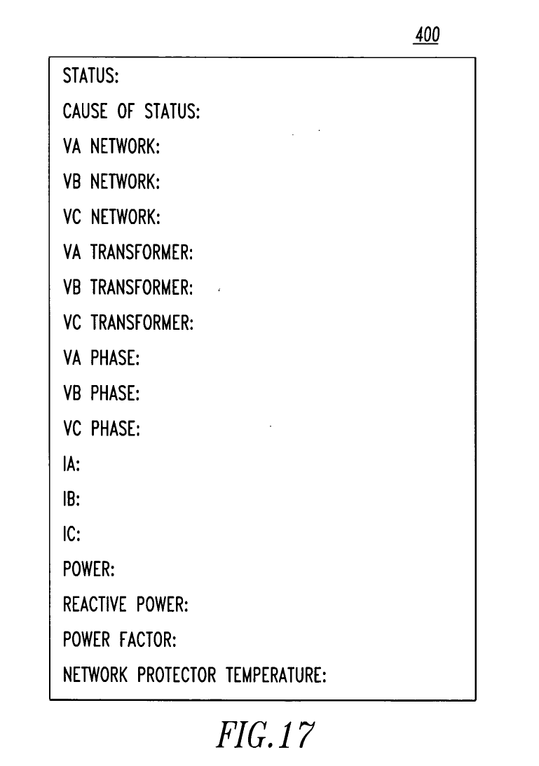

FIGS. 15, 16 and 17 show respective display diagrams 320, 330 and 400 employed by a client system, such as 118,120,122 of FIG. 2, to control and/or monitor the various network protectors, sensors and/or devices. The example links 322,324 of FIG. 15 select a corresponding display screen, such as 330 of FIG. 16, for the particular corresponding node, such as the example network protector NPNU-1000-1-1. Displayed in association with the links 332,334,336,338 of FIG. 16 are the respective last value or status 340,342,344,346 and date and time 348,350,352,354. For example, the following last value or status information are refreshed periodically and automatically: (1) Network Protector Status 340 (e.g., OPEN, CLOSED or TRIPPED); (2) Phase current Status 342 (e.g., ON or OFF); (3) Network Protector Vault Temperature Last value 344 (e.g., degrees Fahrenheit); and (4) Water in Vault Status 346 (e.g., High or Normal). The date and time 348,350,352,354 provide the respective date and time of the corresponding last value or status 340,342,344,346, respectively.

The various configuration links 356,358,360,362 display screens (not shown) that permit the user to configure the corresponding network protector, phase current sensor, network protector vault temperature sensor, and vault water sensor, respectively.

The various view trend links 364,366,368,370 display screens (not shown) that trend the corresponding network protector status, phase current status, vault temperature, and water in vault status, respectively, versus time.

The various download links 372,374,376,378 download the trend information and time values for the corresponding network protector status, phase current status, vault temperature, and water in vault status, respectively.

The Resolve All Events link 380 disarms all the alarms. For example, some automatic or manual actions have been taken beforehand by the crew personnel to resolve the issues in the network protector. The gateway/controller unit, in turn, stops sending alarm signals to the remote control dispatch and monitoring center. The Event History link 382 displays a pop-up display 384 of events needing attention and corresponding dates and times.

By selecting one of the links 332,334,336,338 of FIG. 16, the client system queries the main application of the web server 264 of FIG. 2. In this manner, the local web server functionality allows any local or remote client system (e.g., without limitation, a PC; a PDA) to access the data screens. For example, selecting the network protector link 332 results in the display of the detail table 400 (FIG. 17) of various values operatively associated with the selected network protector.

### EXAMPLE 27

In addition to the periodic and automatic update of the values/status for the sensors and the network protectors, the user may request values/status on demand. When the user clicks on one of the links 332,334,336,338 of FIG. 16, a command is sent to the main application in the web server 264 of the gateway 124 of FIG. 2. The main application receives the command, gets the last value/status stored in memory for the particular node that is being queried, and sends it to the web server 264 which updates the web page with this new value. In the case of the network protectors, the detail table 400 of FIG. 17 includes the new values. In the case of the various sensors, the last value or status (depending on the particular sensor) and the date and time of the sensor queried are updated with the new value.

### EXAMPLE 28

The sensors and network protectors transmit their values/status periodically with a period of about 20 seconds to the main application in the web server 264 of the gateway 124, which refreshes the corresponding web page and stores the last values from the sensors and the network protectors. The main application responds to on demand queries by sending the last values and status of the particular queried node and the web server 264 updates the web page.

In order to improve bandwidth usage, the main application in the web server 264 may send all of the last values and status from all sensors and network protectors, even though the user is interested in one or more particular values.

### EXAMPLE 29

As seen in FIG. 2, the wireless LAN interface 130 and the wireless WAN interface 132 of the gateway 124 enable it to communicate with the PDAs 118,120 or the remote client system 122 (e.g., without limitation, workstation; personal computer (PC)), by employing the wireless LAN 260 or the wireless WAN 262, respectively. These interfaces 130,132 allow the gateway 124 to transmit the data that is collected from a number of network protector(s), sensor(s) and/or device(s) to the PDAs 118,120 or the remote client system 122. These interfaces 130,132 also allow the PDAs 118,120 or the remote client system 122 to transmit control commands to the gateway 124, which control commands, in turn, are sent to the appropriate network protector(s), sensor(s) and/or device(s). The remote client system 122 and the Internet 138 may employ wired and/or wireless communication to access the wireless WAN 262.

### EXAMPLE 30

Physical access to the network protector vault, such as 140 or 142, takes a relatively long time in view of the safety procedures to be followed by the utility crew. The disclosed system 100 allows personnel to quickly assess whether the vault needs to be accessed or not. The system 100 also enables the incorporation of control and monitoring systems (not shown) that can be used for diagnostics and prognostics.

For example, inspection of real-time parametric data, logged data since a previous visit, and video information (if available), can all lead to a relatively quick assessment of network protector health. Should any of this data indicate a potential anomaly, then an in-depth manual inspection can follow. With remote control, the network protectors can be exercised while under close supervision of the data collection portion of the system 100. Some network protectors even include internal diagnostic functionality that further enhances any routine physical operation of the network protector.

Currently, electric utilities rely on physical inspection of the vaults. The disclosed system 100 provides communication to and from the vault from and to the outside world, thereby saving a large number of man-hours. This provides the flexibility to have in-vault, local and remote access to a number of network protectors, a number of devices and/or a number of sensors. Furthermore, in addition to monitoring and/or control applications, the gateway 124 may provide the level of functionality tailored to the particular applications (e.g., a user may be interested only in remote access, only in local access, or only in in-vault communications with a selected number of sensors).

While for clarity of disclosure two sub-network interfaces 126,128 are shown being connected to one gateway 124, it will be appreciated that three or more sub-network interfaces, each including a number of sensors, devices and/or network protectors, may be connected to the single gateway 124, and that a number of gateways, each being connected to a plurality of sub-networks, may be included in a system within the scope of the invention.

As shown in FIG. 9, the example gateway/controller 176B may include auxiliary I/O 402 for monitoring a number of discrete inputs and/or for controlling a number of discrete outputs. It will be appreciated, however, that any of the disclosed gateways may be gateway/controllers and/or any of the disclosed gateway/controllers may be gateways.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power distribution communication system comprising:
a number of network protectors;
a number of sensors or devices;
a number of wirelessly communicating user interfaces; and
a gateway comprising:
a wired communication network interface structured to communicate with at least one of said network protectors, said sensors or said devices,
a first wireless communication network interface structured to wirelessly communicate with at least another one of said network protectors, said sensors or said devices,
a number of second wireless communication network interfaces structured to wirelessly communicate with said wirelessly communicating user interfaces, and
a processor operatively associated with said wired communication network interface, said first wireless communication network interface and said number of second wireless communication network interfaces.

2. The power distribution communication system of claim 1 wherein said number of second wireless communication network interfaces include at least one of a wireless local area communication network interface and a wireless wide area communication network interface.

3. The power distribution communication system of claim 1 wherein said number of second wireless communication network interfaces include a wireless local area communication network interface and a wireless wide area communication network interface.

4. The power distribution communication system of claim 1 wherein said wired communication network interface is an INCOM interface.

5. The power distribution communication system of claim 1 wherein said first wireless communication network interface is a low rate-personal area network interface.

6. The power distribution communication system of claim 1 wherein one of said wirelessly communicating user interfaces is a portable wireless communicating device located above ground; and wherein one of said network protectors, said sensors or said devices communicating with said gateway is located below ground.

7. The power distribution communication system of claim 6 wherein said number of second wireless communication network interfaces includes a wireless local area communication network interface structured to communicate with said portable wireless communicating device.

8. The power distribution communication system of claim 6 wherein said number of second wireless communication network interfaces include a wireless wide area communication network interface structured to communicate with said portable wireless communicating device.

9. The power distribution communication system of claim 6 wherein said portable wireless communicating device is structured to: (a) monitor a number of said network protectors or a number of said sensors; (b) control a number of said network protectors or a number of said devices; (c) or accumulate data from a plurality of said network protectors and a plurality of said sensors over a geographical region.

10. The power distribution communication system of claim 9 wherein the size of said geographical region is about the size of a city block.

11. The power distribution communication system of claim 1 wherein one of said wirelessly communicating user interfaces is a control, monitoring or dispatch center located above ground; wherein one of said network protectors, said sensors or said devices communicating with said gateway is located below ground; and wherein said number of second wireless communication network interfaces include a wireless wide area communication network interface structured to communicate with said control, monitoring or dispatch center through a global communication network.

12. The power distribution communication system of claim 1 wherein one of said wirelessly communicating user interfaces is structured to communicate with, control or monitor a number of said network protectors, said sensors or said devices.

13. The power distribution communication system of claim 1 wherein said processor selectively requests and receives data from said at least one of said network protectors, said sensors or said devices or from said at least another one of said network protectors, said sensors or said devices; and wherein said processor selectively requests said data in response to a data request wirelessly received from one of said wirelessly communicating user interfaces.

14. The power distribution communication system of claim 1 wherein said processor selectively provides a control command to said at least one of said network protectors, said sensors or said devices or to said at least another one of said network protectors, said sensors or said devices; and wherein said processor selectively provides said control command in response to a command wirelessly received from one of said wirelessly communicating user interfaces.

15. The power distribution communication system of claim 14 wherein said control command includes one of a breaker trip command and a breaker re-close command.

16. The power distribution communication system of claim 1 wherein said gateway is located in a first underground vault; wherein said network protectors include a first network protector located in said first underground vault and a second network protector located in a second underground vault located about adjacent to said first underground vault; wherein said wired communication network interface communicates with said second network protector; and wherein said first wireless communication network interface wirelessly communicates with said first network protector.

17. The power distribution communication system of claim 1 wherein said processor receives data from said network protectors or said sensors through at least one of said wired communication network interface and said first wireless communication network interface; and wherein said processor sends control commands to said network protectors or said devices through at least one of said wired communication network interface and said first wireless communication network interface.

18. The power distribution communication system of claim 17 wherein said data includes at least one of temperature, humidity, pressure, liquid level, voltage, and current.

19. The power distribution communication system of claim 1 wherein one of said wirelessly communicating user interfaces is structured to: (a) monitor a number of said network protectors or a number of said sensors; (b) control a number of said network protectors or a number of said devices; (c) or accumulate data from a plurality of said network protectors and a plurality of said sensors over a geographical region.

20. The power distribution communication system of claim 19 wherein the size of said geographical region is about the size of a city.

21. The power distribution communication system of claim 1 wherein one of said wirelessly communicating user interfaces is operatively associated with a remote system; wherein one of said network protectors, said sensors or said devices communicating with said gateway is located below ground; and wherein said number of second wireless communication network interfaces include a wireless wide area communication network interface structured to communicate with said remote system through a global communication network.

22. The power distribution communication system of claim 21 wherein said remote system is structured to (a) monitor a number of said network protectors or a number of said sensors; (b) control a number of said network protectors or a number of said devices; or (c) accumulate data from a plurality of said network protectors and a plurality of said sensors over a geographical region.

23. The power distribution communication system of claim 1 wherein said gateway is located in a first underground vault; wherein a plurality of said network protectors, said sensors and said devices are located in a second underground vault located about adjacent to said first underground vault; wherein said wired communication network interface is structured to communicate with a data collector including a wired communication network interface communicating with a number of said network protectors, said sensors and said devices located in said second underground vault and a wireless communication network interface wirelessly communicating with a number of said network protectors, said sensors and said devices located in said second underground vault.

24. A power distribution communication system comprising:
a number of network protectors;
a number of sensors or devices;
a number of wirelessly communicating user interfaces;
a wired communication network;
a gateway comprising:
a wired communication network interface structured to communicate with a first group of some of said network protectors, said sensors or said devices over said wired communication network,
a number of first wireless communication network interfaces structured to wirelessly communicate with said wirelessly communicating user interfaces, and
a processor operatively associated with said wired communication network interface and said number of first wireless communication network interfaces; and
a number of second communication network interfaces structured to provide communications between: (a) said wired communication network interface through said wired communication network, and (b) a second group of some of said network protectors, said sensors or said devices through wireless communications, said second group being different than said first group.

25. The power distribution communication system of claim 24 wherein said number of first wireless communication network interfaces is one first wireless communication network interface.

26. The power distribution communication system of claim 25 wherein said one first wireless communication network interface is a Wi-Fi Hot Spot interface.

27. The power distribution communication system of claim 24 wherein said number of first wireless communication network interfaces is a first wireless communication network interface and a second wireless communication network interface.

28. The power distribution communication system of claim 27 wherein said first wireless communication network interface is a Wi-Fi Hot Spot interface and said second wireless communication network interface is one of an Ethernet cellular modem, an Ethernet radio modem and a fiber optic modem.
